(19) United States
(12) Patent Application Publication
(10) Pub. No.: US 2017/0171198 A1
(43) Pub. Date: Jun. 15, 2017

(54) COMMUNICATION SYSTEM AND INFORMATION PROCESSING METHOD

(71) Applicant: Sharp Kabushiki Kaisha, Sakai-shi , Osaka (JP)

(72) Inventors: Yuhsuke YAMADA, Sakai-shi (JP); Misuzu KAWAMURA, Sakai-shi (JP); Masaru TAKEUCHI, Sakai-shi (JP); Akira FUJIWARA, Sakai-shi (JP); Toshikazu HASHIMOTO, Sakai-shi (JP)

(73) Assignee: Sharp Kabushiki Kaisha, Sakai-shi , Osaka (JP)

(21) Appl. No.: 15/115,970

(22) PCT Filed: Jan. 20, 2015
(86) PCT No.: PCT/JP2015/051296

§ 371 Date: Aug. 2, 2016

(30) Foreign Application Priority Data
Feb. 4, 2014 (JP) 2014-019843

(51) Int. Cl. H04L 29/06

(52) U.S. Cl. CPC H04L 63/0876

(57) ABSTRACT

A communication system includes: a server apparatus; and a terminal apparatus that becomes capable of accessing the server apparatus through authentication based on information for identifying a user, wherein upon receiving an input of first identification information after the authentication, the terminal apparatus sends the first identification information to the server apparatus via a first communication line, the server apparatus receives second identification information sent from an electronic apparatus via a second communication line, the second identification information being unique to the electronic apparatus, upon receiving the first identification information and the second identification information, the server apparatus determines whether the first identification information matches part of the second identification information, and if the first identification information matches the part of the second identification information, the server apparatus registers the electronic apparatus in association with the information for identifying the user.

### TECHNICAL FIELD

The present invention relates to a communication system and an information processing method.

### BACKGROUND ART

Conventionally, a determination has been made as to whether information for identifying a user (identification information) has been legitimately inputted. For example, PTL 1 discloses the following “method for confirming identification information”:

A user terminal sends authentication information of a user to a server apparatus storing identification information of the user. The server apparatus, if having succeeded in the authentication of the user by the authentication information sent from the user terminal, generates first information (i.e. information equivalent to a cookie in HTTP communication) that establishes a predetermined relationship with the identification information of the user, and sends the first information thus generated to the user terminal. The user terminal requires the user to input the identification information. The user terminal sends, to the server apparatus, the identification information thus inputted and the first information stored in association with an identification name of the server apparatus. If no predetermined relationship is established between the identification information sent from the user terminal and the first information, the server apparatus determines that the identification information thus received has not been legitimately inputted.

### CITATION LIST

### Patent Literature

PTL 1: Japanese Unexamined Patent Application Publication No. 2012-103739

### SUMMARY OF INVENTION

### Technical Problem

However, the user terminal may be an electronic apparatus that does not have an input device with a high degree of freedom, such as a touch panel or a numerical keypad, or a display device such as an LCD. An example of such an electronic apparatus is a HEMS (home energy management system) controller that functions as a relay to home appliances and the like. Such an electronic apparatus makes it difficult for the electronic apparatus to be operated by a particular user.

The present invention, made in view of the foregoing problems, has as an object to provide a communication system and an information processing method that enable an electronic apparatus to be registered in a server apparatus by a particular user.

### Solution to Problem

In an aspect of the present invention, a communication system includes: a server apparatus; and a terminal apparatus that becomes capable of accessing the server apparatus through authentication based on information for identifying a user. Upon receiving an input of first identification information after the authentication, the terminal apparatus sends the first identification information to the server apparatus via a first communication line. The server apparatus receives second identification information sent from an electronic apparatus via a second communication line, the second identification information being unique to the electronic apparatus. Upon receiving the first identification information and the second identification information, the server apparatus determines whether the first identification information matches part of the second identification information. If the first identification information matches the part of the second identification information, the server apparatus registers the electronic apparatus in association with the information for identifying the user.

Preferably, the server apparatus registers the electronic apparatus by associating, with the information for identifying the user, the second identification information or third identification information generated from the second identification information on the basis of a predetermined rule, the third identification information being unique to the electronic apparatus.

Preferably, the server apparatus is capable of communicating with one or more other electronic apparatuses, as well as the electronic apparatus, via the second communication line. Upon receiving, from the terminal apparatus, a command to control a home appliance, the server apparatus sends the command to that one of the plurality of electronic apparatuses which is specified by the second or third identification information associated with the information for identifying the user.

Preferably, if having determined that the first identification information matches the part of the second identification information, the server apparatus sends the second identification information to the terminal apparatus. The terminal apparatus outputs the second identification information to a display of the terminal apparatus. Upon receiving a predetermined input with the second identification information displayed on the display, the terminal apparatus sends a predetermined signal to the server apparatus. Upon receiving the predetermined signal, the server apparatus stores the second or third identification information and the information for identifying the user in association with each other.

Preferably, upon receiving the second identification information during a first period between the reception of the first identification information and passage of a predetermined period of time, the server apparatus determines whether the first identification information matches the part of the second identification information.

In another aspect of the present invention, an information processing method is executed in a communication system including a server apparatus and a terminal apparatus that becomes capable of accessing the server apparatus through authentication based on information for identifying a user. The information processing method includes: a step in which, upon receiving an input of first identification information after the authentication, the terminal apparatus sends the first identification information to the server apparatus via a first communication line; a step in which the server apparatus receives second identification information sent from an electronic apparatus via a second communication line, the second identification information being unique to the electronic apparatus; a step in which, upon receiving the first identification information and the second identification information, the server apparatus determines whether the first identification information matches part of the second identification information; and a step in which if the first identification information matches the part of the second identification information, the server apparatus registers the electronic apparatus in association with the information for identifying the user.

### Advantageous Effects of Invention

The present invention makes it possible for the electronic apparatus to be registered in the server apparatus by a particular user.

### BRIEF DESCRIPTION OF DRAWINGS

FIG. 1 is a diagram for schematically explaining a configuration of a communication system 1.

FIG. 2 is a diagram showing the appearance of a HEMS controller 700.

FIG. 3 is a diagram showing the flow of a process in the communication system 1.

FIG. 4 is a flow chart for explaining the flow of a process in a smartphone 300.

FIG. 5 is a flow chart for explaining the flow of a process in the HEMS controller 700.

FIG. 6 is a flow chart for explaining details of an exclusive process that is performed to send an acknowledgement α in sequence SQ4 of FIG. 3.

FIG. 7 is a flow chart for explaining details of a process that is performed to send an acknowledgement β in sequence SQ12 of FIG. 3.

FIG. 8 is a diagram for schematically explaining a configuration of a database 113 stored in a server apparatus 100.

FIG. 9 is a diagram for explaining a user interface of the smartphone 300.

FIG. 10 is a diagram for explaining the user interface of the smartphone 300.

FIG. 11 is a functional block diagram for explaining a functional configuration of the server apparatus 100.

FIG. 12 is a diagram showing a typical example of a hardware configuration of the server apparatus 100.

FIG. 13 is a block diagram of the HEMS controller 700.

FIG. 14 is a diagram showing a hardware configuration of the smartphone 300.

FIG. 15 is a flow chart for explaining the flow of a process that is regularly executed by the server apparatus 100.

FIG. 16 is a flow chart for explaining the flow of a process that the server 100 executes upon receiving an acknowledgement γ from the smartphone 300.

### DESCRIPTION OF EMBODIMENTS

A communication system according to each embodiment of the present invention will be described below with reference to the drawings. Further, in the following description, the same members are given the same reference signs. The same applies to the names and functions of these members. Therefore, these members will not be repeatedly described in detail.

### A. Overview of Communication System

(a1. Overall Configuration)

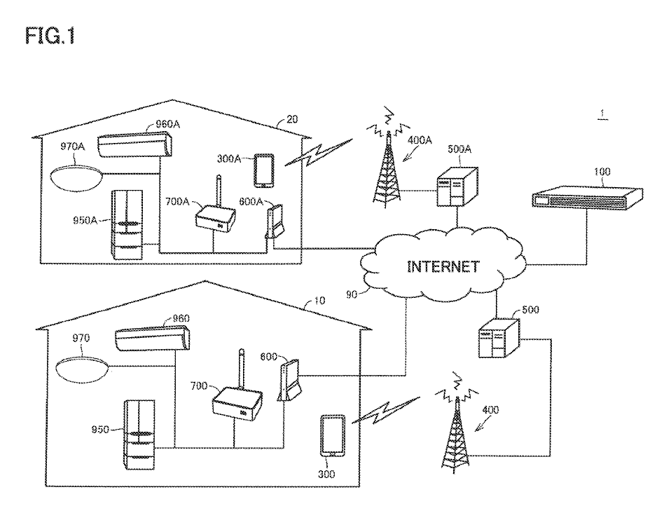

FIG. 1 is a diagram for schematically explaining a configuration of a communication system 1. As shown in FIG. 1, the communication system 1 includes a server apparatus 100, a plurality of smartphones 300 and 300A, a plurality of base station apparatuses 400 and 400A, a plurality of MMEs (mobility management entities) 500 and 500A, a plurality of broadband routers 600 and 600A, a plurality of HEMS controllers 700 and 700A, and a plurality of nodes 950, 950A, 960, 960A, 970, and 970A.

The “nodes” are communication devices (IP-compatible devices) having IP addresses. In general, examples of the nodes include personal computers, printers, NASs (network-attached storages), tablet terminals, AV (audiovisual) devices, and white home appliances. Some or all of the plurality of nodes 950, 950A, 960, 960A, 970, and 970A are “ECHONET Lite nodes”. The present embodiment assumes that all of the plurality of nodes 950, 950A, 960, 960A, 970, and 970A are ECHONET Lite nodes.

It should be noted that FIG. 1 shows a case where the nodes 950 and 950A are refrigerators, the nodes 960 and 960A are air conditioners, and the nodes 970 and 970A are lighting devices.

The smartphone 300, the MME 500, the broadband router 600, the HEMS controller 700, and the plurality of nodes 950, 960, and 970 are disposed in a building 10. Further, the smartphone 300A, the MME 500A, the broadband router 600A, the HEMS controller 700A, and the plurality of nodes 950A, 960A, and 970A are disposed in a building 20. It should be noted that while the present embodiment shows only two buildings 10 and 20 for simplicity of explanation, the present embodiment is not limited to this. That is, the present embodiment is not limited to particular configurations, provided two or more buildings are each equipped with a HEMS controller.

The broadband router 600 includes at least a cable LAN, and the HEMS controller 700 is connected to the broadband router 600 through the cable LAN. Preferably, the broadband router 600 includes a wireless LAN, and the plurality of nodes 950, 960, and 970 are connected to the broadband router 600 through the wireless LAN. Alternatively, the plurality of nodes 950, 960, and 970 may be connected to the broadband router 600 through a cable LAN. The HEMS controller 700 finds an ECHONET Lite node that is present on a subnet hanging down from the broadband router 600, and maintains and manages a node list in the latest condition. The HEMS controller 700 can communicate with the plurality of nodes 950, 960, and 970.

Similarly, the HEMS controller 700A is connected to the broadband router 600A through a cable LAN. Preferably, the broadband router 600A includes a wireless LAN, and the plurality of nodes 950A, 960A, and 970A are connected to the broadband router 600A through the wireless LAN.

Alternatively, the plurality of nodes 950A, 960A, and 970A may be connected to the broadband router 600A through a cable LAN. The HEMS controller 700A finds an ECHONET Lite node that is present on a subnet hanging down from the broadband router 600A, and maintains and manages a node list in the latest condition. The HEMS controller 700A can communicate with the plurality of nodes 950A, 960A, and 970A.

The broadband routers 600 and 600A are connected to the Internet.

The smartphones 300 and 300A are connectable to the Internet 90 via 3G (third-generation) lines, LTE (long term evolution) lines, or the like. When in the building 10, the smartphone 300 is connected to the Internet 90 via the base station apparatus 400 and the MME 500. Further, when in the building 20, the smartphone 300A is connected to the Internet 90 via the base station apparatus 400A and the MME 500A. The smartphones 300 and 300A (which are mobile devices) are not always in the buildings 10 and 20, respectively. The smartphones 300 and 300A may be connected from places where they have taken out to.

As noted above, the HEMS controller 700 and the smartphone 300 communicate with the server apparatus 100 through different communication lines from each other. Similarly, the HEMS controller 700A and the smartphone 300A communicate with the server apparatus 100 through different communication lines from each other. The HEMS controller 700 and the smartphone 300 do not directly communicate with each other, nor do they need to do so.

For convenience of explanation, the following description focuses particular attention on the HEMS controller 700, the smartphone 300, and the server apparatus 100. In particular, the following description deals with a case where the HEMS controller 700 is registered in the server apparatus 100 by a user of the smartphone 300. More specifically, the following description deals with a case where a user who starts to use the HEMS controller 700 uses the smartphone 300 to register the HEMS controller 700 in the server apparatus 100.

(a2. Appearance of HEMS Controller 700)

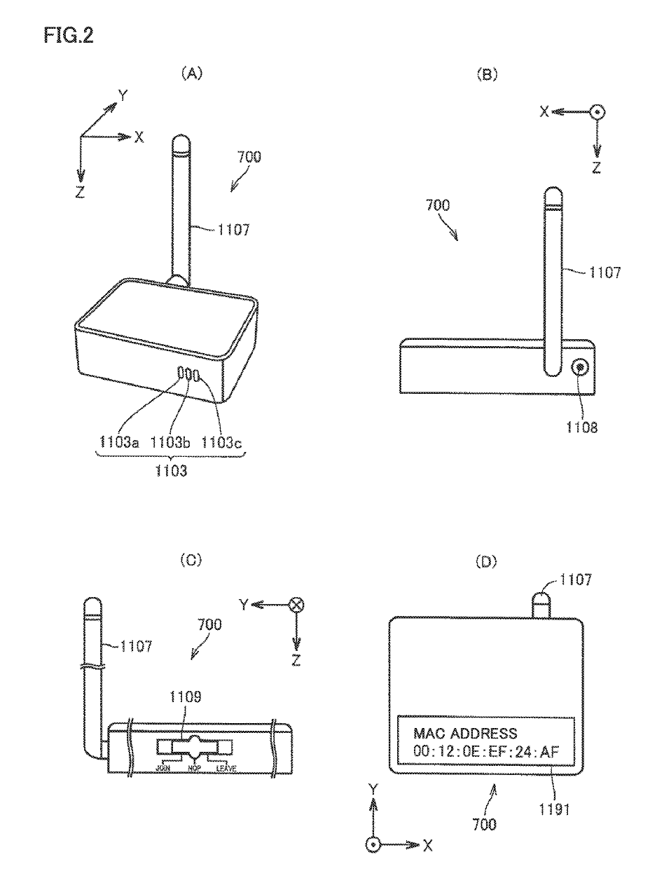

FIG. 2 is a diagram showing the appearance of the HEMS controller 700. FIG. 2(A) is a perspective view of the HEMS controller 700. FIG. 2(B) is a view of the HEMS controller 700 from a side. FIG. 2(C) is an enlarged view of a main part of another side of the HEMS controller 700. FIG. 2(D) is a back view of the HEMS controller 700.

As shown in FIG. 2(A), the HEMS controller 700 includes a light-emitting element 1103 and an antenna 1107. The light-emitting element 1103 is composed of three LEDs (light-emitting diodes) 1103a, 1103b, and 1103c for indicating the operating state and the like of the HEMS controller 700.

The LED 1103 is a light-emitting element (power LED) for indicating whether the HEMS controller 700 is in a power-on state or a power-off state. Further, the LED 1103a indicates a status of communication with the server apparatus 100. The LED 1103b is a light-emitting element (router LED) for indicating a state of communication with the broadband router 600. The LED 1103c is not described here, as it is irrelevant to the present invention.

As shown in FIG. 2(B), the HEMS controller 700 further includes a push button 1108 in a surface opposite to a surface in which the light-emitting element 1103 is provided. Keeping the push button 1108 depressed for 5 seconds or longer causes the HEMS controller 700 to start to communicate with the server apparatus 100.

As shown in FIG. 2(D), the HEMS controller 700 has its MAC address 1191 written (printed) on a back surface thereof. It should be noted that the following description takes, as an example, a case where the MAC address of the HEMS controller 700 is “00:12:0E:EF:24:AF”.

It should be noted that, for the avoidance of repetition, the HEMS controller 700A, which is identical in configuration to the HEMS controller 700, is not described here. Note, however, that the HEMS controller 700A has its MAC address written on a back surface thereof and the MAC address is different from that of the HEMS controller 700.

It should be noted that the embodiment of the present invention uses an MAC address as an example of identification information that satisfies all of the following conditions (i) to (iii):

(i) The identification information is a number that serves as a unique identifier for a HEMS controller.
(ii) A label of the number is pasted on a back surface or the like.
(iii) The identification information is acquirable from software (stored in a nonvolatile memory).

The identification information is not limited to an MAC address but may be another type of address, provided it satisfies all of the foregoing conditions (i) to (iii).

### B. Processing of Information in Communication System

(b1. Flow of Process in Communication System 1)

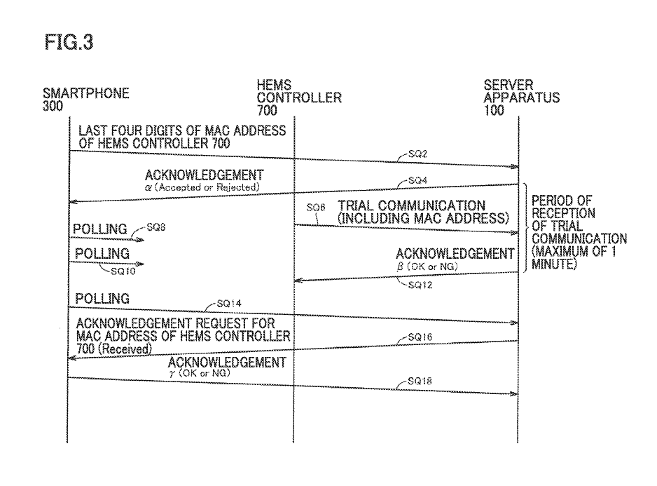

FIG. 3 is a diagram showing the flow of a process in the communication system 1. Specifically, FIG. 3 is a sequence chart showing the flow of data processing among the smartphone 300, the HEMS controller 700, and the server 100. It should be noted that the following description assumes that the smartphone 300 has become capable of accessing the server apparatus 100 (i.e. has come into a logged-in state) through authentication based on information for identifying the user (hereinafter referred to as “user ID”) and a password set in advance. Further, it is assumed that the user of the smartphone 300 can visually confirm the MAC address (see FIG. 2(D)) written on the back surface of the HEMS controller 700.

As shown in FIG. 3, the smartphone 300 receives a user input of a character string (i.e. an arrangement of numbers and letters in hexadecimal form) of the last four digits of the MAC address of the HEMS controller 700. In sequence SQ2, the character string thus inputted (i.e. the character string of the last four digits) is sent to the server apparatus 100. For example, when the MAC address of the HEMS controller 700 is “00:12:0E:EF:24:AF”, the smartphone 300 sends “24AF” to the server apparatus 100 as the character string of the last four digits.

In sequence SQ4, the server 100 sends an acknowledgement α to the smartphone 300. Specifically, the server apparatus 100 acknowledges whether it has received a trial communication of a character string that is identical to the character string of the last four digits received from the smartphone 300.

If not having received a trial communication of an identical character string, the server apparatus 100 notifies the smartphone 300 of “Accepted” as the acknowledgement α. If having already received a trial communication of an identical character string, the server apparatus 100 notifies the smartphone 300 of “Rejected” as the acknowledgement α. The server apparatus 100 performs exclusive control with the character string of the last four digits. That is, the server apparatus 100 does not accept two or more trial communications of identical character strings at a time.

For example, in a case where the last four digits of the MAC address of the smartphone 300A, which is operated by another user, coincides with the last four digits of the MAC address of the smartphone 300 (“24AF”) and the server apparatus 100 has already received the character string “24AF” from the smartphone 300, the server apparatus 100 notifies the smartphone 300 of “Rejected” as the acknowledgement α. In the case of notification of “Rejected”, sequence SQ6 and the subsequent sequences are not carried out.

For exclusive control of the server apparatus 100, a mutex needs only be prepared for each character string (or after conversion of a character string into a numerical value). A hash table of character strings into which keys have been converted and mutexes into which values have been converted is prepared. A character string (or a numerical value) is converted into a key, and the hash table is searched for the presence of a value corresponding to the key.

If having notified “Accepted” as the acknowledgement α, the server apparatus 100 shifts to a period of reception of a trial communication. The period of reception of a trial communication is a maximum of 1 minute. It should be noted that if having performed a process based on sequence SQ12 described below, the server apparatus 100 immediately terminates the period of reception of a trial communication.

Next, the user operates the push button 110 of the HEMS controller 700 to start a trial communication. Specifically, the HEMS controller 700 sends, to the server apparatus 100, data whose main text contains the MAC address of the HEMS controller 700. It should be noted that a destination address to the server apparatus 100 is stored in advance in the HEMS controller 700.

In sequence SQ12, the server apparatus 100 sends an acknowledgement β to the HEMS controller 700 in response to the trial communication.

Specifically, the server apparatus 100 looks at the last four digits of the MAC address received from the HEMS controller 700 through the trial communication, and determines whether there is a period of reception of a trial communication that matches the last four digits. If there is a period of reception of a trial communication that matches the last four digits, the server apparatus 100 notifies the HEMS controller 700 of “OK” as the acknowledgement β. If there is no period of reception of a trial communication that matches the last four digits, the server apparatus 100 notifies the HEMS controller 700 of “NG” as the acknowledgement β. In the case of returning of “NG” as the acknowledgement β, sequence SQ16 and the subsequent sequences are not carried out.

As shown in sequences SQ8, SQ10, and SQ14, the smartphone 300 regularly executes polling on the server apparatus 100 upon receiving the acknowledgement α from the server apparatus 100. In sequence SQ16, the server apparatus 100, if having notified “OK” as the acknowledgement β, sends, to the smartphone 300, an acknowledgement request for the full MAC address of the HEMS controller 700 (“Received”). Specifically, the server apparatus 100 asks the user of the smartphone 300 to acknowledge whether the HEMS controller 700 is correct.

In sequence SQ18, the smartphone 300 sends, to the server apparatus 100, an acknowledgement γ from the user as to whether the MAC address is correct. If the user judges that the MAC address is correct, the smartphone 300 notifies the server apparatus 100 of “OK” as the acknowledgement γ. If the user judges that the MAC address is wrong, the smartphone 300 notifies the server apparatus 100 of “NG” as the acknowledgement γ.

If having received notification of “OK” as the acknowledgement γ, the server apparatus 100 registers the HEMS controller 700 in the server apparatus 100 in association with the user ID (i.e. the user ID used for the authentication) of the user of the smartphone 300.

If having received notification of “NG” as the acknowledgement γ, the server apparatus 100 does not register the HEMS controller 700 and the user ID in association with each other.

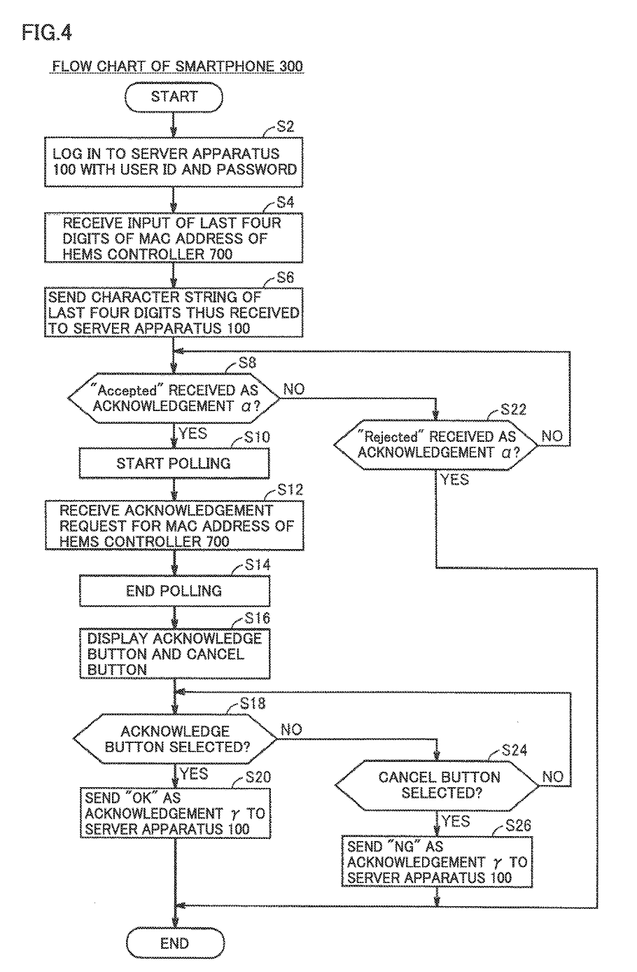

Such a series of actions as that described above enables the HEMS controller 700 to be registered in the server apparatus 100 by a particular user (i.e. the user of the smartphone 300). In the following, the flows of processes in the smartphone 300, the HEMS controller 700, and the server apparatus 100 are described individually with reference to FIGS. 4 to 7.

(b2. Flow of Process in Smartphone 300)

FIG. 4 is a flow chart for explaining the flow of a process in the smartphone 300. The process in the smartphone 300 may be achieved by a common browser installed on the smartphone 300 or may be achieved as a dedicated application. Preferably, the process in the smartphone 300 is achieved in the former form, and content 111 in the server apparatus 100 is displayed by the browser.

It should be noted that, in the former case, the user of the smartphone 300 inputs an address (URL: uniform resource locator) of the server apparatus 100 to a URL input section of the browser. The address of the server apparatus 100 is written in an instruction manual or the like for the HEMS controller 700. Alternatively, a QR Code (registered trademark) is printed on the instruction manual or the like, and the address of the server apparatus 100 is inputted by scanning the QR Code. Each step in the flow chart of FIG. 4 is achieved by cooperation between the smartphone 300 and the server apparatus 100.

As shown in FIG. 4, in step S2, the smartphone 300 logs in to the server apparatus 100 through an operation performed by the user of the smartphone 300 with the user ID and the password.

The smartphone 300 selects “Registration of HEMS Controller” from a menu on a top screen. In step S4, the smartphone 300 receives an input of the last four digits of the MAC address of the HEMS controller 700. In step S6, the smartphone 300 sends a character string of the last four digits thus received to the server apparatus 100. In step S8, the smartphone 300 determines whether it has received “Accepted” as an acknowledgement α from the server apparatus 100.

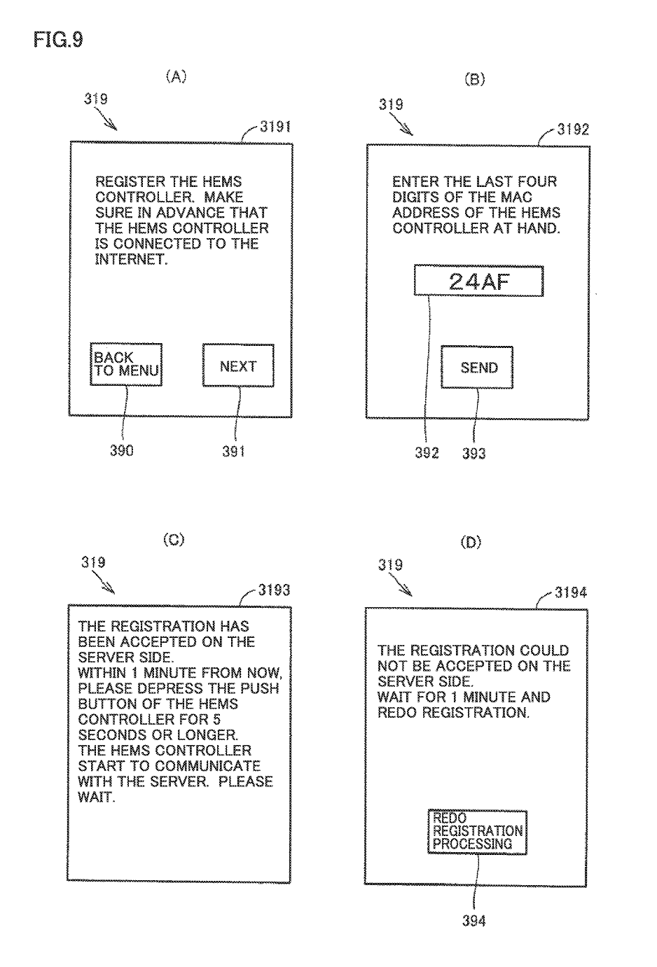

If having determined that it has received “Accepted” (YES in step S8), the smartphone 300 starts polling in step S10. If having determined that it has not received “Accepted” (NO in step S8), the smartphone 300 determines, in step S22, whether it has received “Rejected” as an acknowledgement. If having determined that it has received “Rejected” (YES in step S22), the smartphone 300 displays an error display screen (i.e. a screen 3194 of FIG. 9(D)). If having determined that it has not received “Rejected” (NO in step S22), the smartphone 300 proceeds to step S8.

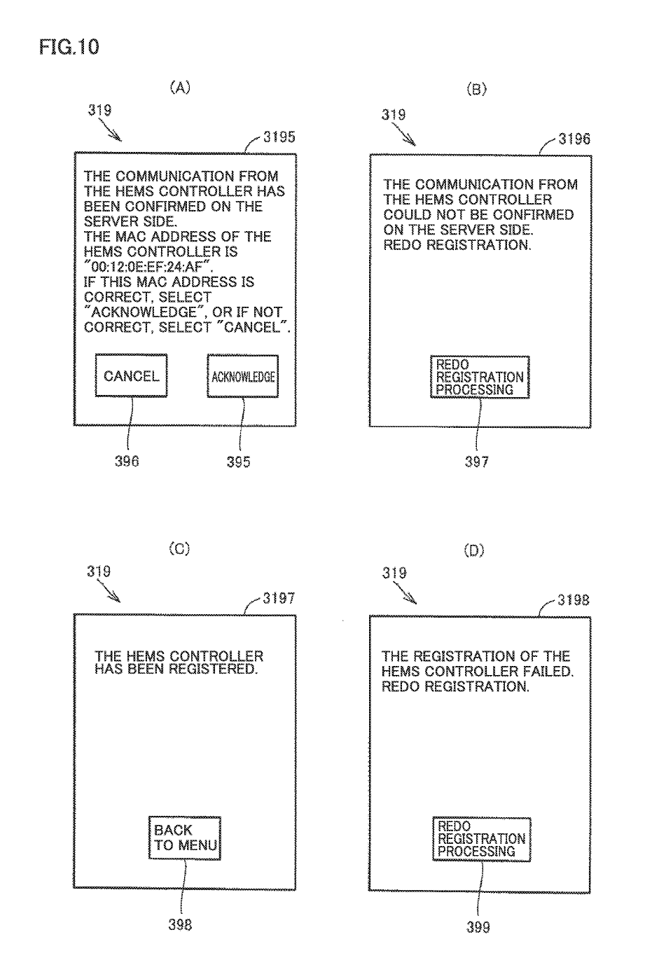

In step S12, the smartphone 300 receives an acknowledgment request for the MAC address of the HEMS controller 700 from the server apparatus 100. In step S14, the smartphone 300 ends the polling. In step S16, the smartphone 300 displays an acknowledge button (i.e. an acknowledge button 395 of FIG. 10(A) and a cancel button (i.e. a cancel button 396 of FIG. 10(A)). In step S18, the smartphone 300 determines whether the acknowledge button has been selected. If having determined that the acknowledge button has been selected (YES in step S18), the smartphone 300 sends “OK” as an acknowledgement γ to the server apparatus 100 in step 20. If having determined that the acknowledge button has not been selected (NO in step S18), the smartphone 300 determines, in step S24, whether the cancel button has been selected.

If having determined that the cancel button has been selected (YES in step S24), the smartphone 300 sends “NG” as an acknowledgement γ to the server apparatus 100 in step 26. If having determined that the cancel button has not been selected (NO in step S24), the smartphone 300 proceeds to step S18.

(b3. Flow of Process in HEMS Controller 700)

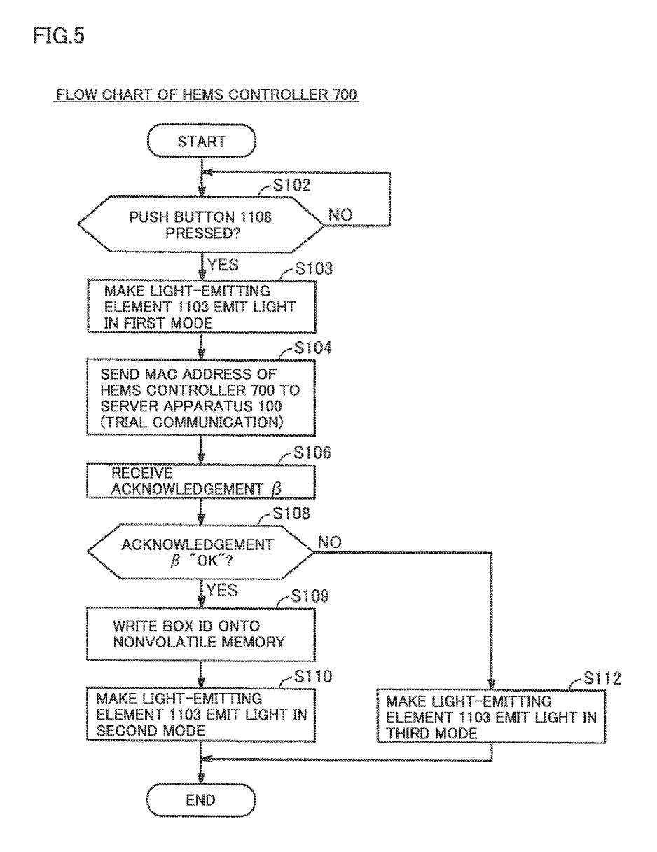

FIG. 5 is a flow chart for explaining the flow of a process in the HEMS controller 700. As shown in FIG. 5, in step S102, the HEMS controller 700 determines whether the push button 1108 of the HEMS controller 700 has been depressed for 5 seconds or longer. If having determined that the push button 1108 has been depressed for 5 seconds or longer, the HEMS controller 700 causes the light-emitting element 1103, in step S103, to emit light in a first mode. An example of a zeroth mode is a mode in which the LED 1103a normally blinks (e.g. repeatedly flashes on and off at intervals of 500 ms).

In step S104, the HEMS controller 700 sends the MAC address of the HEMS controller 700 to the server apparatus 100 (trial communication).

In step S106, the HEMS controller 700 receives an acknowledgement β. In step S108, the HEMS controller 700 determines whether the acknowledgement β is “OK”. If having determined that the acknowledgement β is “OK” (YES in step S108), the HEMS controller 700 causes the light-emitting element 1103, in step S110, to emit light in a second mode. If having determined that the acknowledgement β is not “OK” (NO in step S108), the HEMS controller 700 causes the light-emitting element 1103, in step S112, to emit light in a third mode.

If having determined that the acknowledgement β is “OK”, the HEMS controller 700 receives a box ID from the server apparatus 100 and therefore writes the box ID thus received onto a nonvolatile memory.

An example of the first mode is a mode in which the LED 1103a stays on for 5 seconds (continuous lighting) and then stays off for 2 seconds. An example of the second mode is a mode in which the LED 1103a blinks at a high speed for 5 seconds (e.g. repeatedly flashes on and off at intervals of 250 ms) and then stays off for 2 seconds. It should be noted that in either of the first and second modes, the LED 1103a continuously lights after having stayed off for the aforementioned 2 seconds.

It should be noted that if the server apparatus 100 was unable to receive, within the period of reception of a trial communication, the MAC address sent by the HEMS controller 700 in step S104, the server apparatus 100 notifies the HEMS controller 700 of “NG” as the acknowledgement β.

(b4. Flow of Process in Server Apparatus 100)

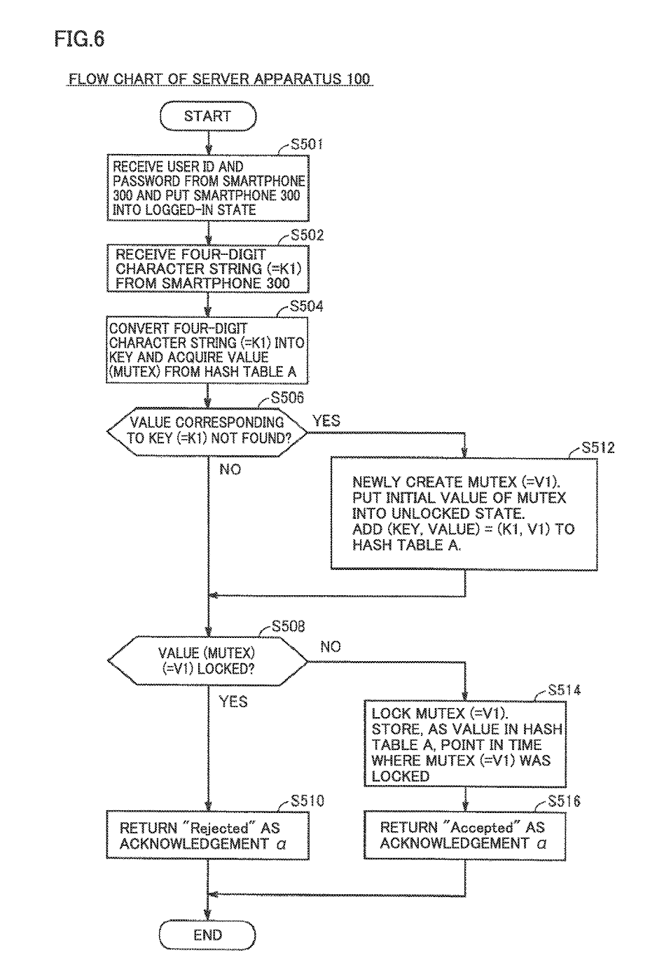

FIG. 6 is a flow chart for explaining details of an exclusive process that is performed to send an acknowledgement α in sequence SQ4 of FIG. 3. As shown in FIG. 6, in step S501, the server apparatus 100 receives the user ID and the password from the smartphone 300 and puts the smartphone 300 into a logged-in state.

In step S502, the server apparatus 100 receives a four-digit character string (=K1) from the smartphone 300 (which corresponds to sequence SQ2 of FIG. 3). In step S504, the server apparatus 100 converts the four-digit character string (=K1) thus received into a key and acquires a value (mutex) from a hash table A stored in advance. It should be noted that the hash table A is constituted by containing plural pieces of data represented by “(key, value)=(character string, mutex)” relationships.

In step S506, the server apparatus 100 determines whether the hash table A has a value corresponding to the key (K1). If having determined that the hash table A does not have such a value (YES in step S506), the server apparatus 100 first newly creates a mutex (=V1) in step S512. Then, the server apparatus 100 puts an initial value of the mutex thus newly created into an unlocked state. Furthermore, the server apparatus 100 adds new data “(key, value)=(K1, V1)” to the hash table A, and proceeds to step S508. If having determined that the hash table A has such a value (NO in step S506), the server apparatus 100 determines, in step S508, whether the value (mutex) (=V1) is locked.

If having determined that the value (mutex) (=V1) is locked (YES in step S508), the server apparatus 100 returns “Rejected” as the acknowledgement α to the smartphone 300 in step S510 (sequence SQ4 of FIG. 3). If having determined that the value (mutex) (=V1) is not locked (NO in step S508), the server apparatus 100 first locks the mutex (=V1) in step S514. Furthermore, the server apparatus 100 stores, as a value in the hash table A, the point in time where the mutex (=V1) was locked. In step S516, the server apparatus 100 returns “Accepted” as the acknowledgement α to the server apparatus 100 in step S516 (sequence SQ4 of FIG. 3).

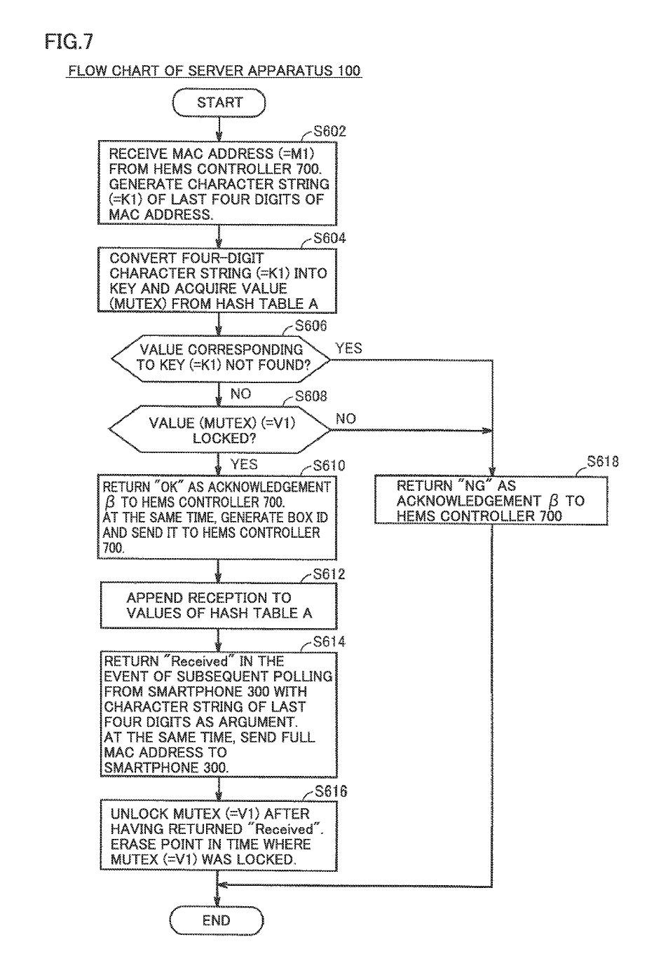

FIG. 7 is a flow chart for explaining details of a process that is performed to send an acknowledgement β in sequence SQ12 of FIG. 3. That is, FIG. 7 is a flow chart for explaining the flow of a process that the server apparatus 100 executes upon receiving a trial communication from the HEMS controller 700 in sequence SQ6.

As shown in FIG. 7, in step S602, the server apparatus 700 receives an MAC address (=M1) from the HEMS controller 700 (which corresponds to sequence SQ6 of FIG. 3). Furthermore, the server apparatus 100 generates a character string (=k1) of the last four digits of the MAC address. In step S604, the server apparatus 100 converts the four-digit character string (=K1) into a key and acquires a value (mutex) from the hash table A.

In step S606, the server apparatus 100 determines whether the hash table A has a value corresponding to the key (=K1). If having determined that the hash table A does not have such a value (YES in step S606), the server apparatus 100 returns “NG” as the acknowledgement β to the HEMS controller 700 in step S618 (sequence SQ12 of FIG. 3). If having determined that the hash table A has such a value (NO in step S606), the server apparatus 100 determines, in step S608, whether the value (mutex) (=V1) is locked.

If having determined that the value (mutex) (=V1) is not locked (NO in step S608), the server apparatus 100 proceeds to step S618. If having determined that the value (mutex) (=V1) is locked (YES in step S608), the server apparatus 100 returns “OK” as the acknowledgement β to the HEMS controller 700 in step S610 (sequence SQ12 of FIG. 3). Further, while returning “OK” to the HEMS controller 700, the server apparatus 100 generates and sends a box ID.

In step S612, the server apparatus 100 appends the reception of the trial communication to the hash table A. In step S614, the server apparatus 100 returns “Received” to the smartphone 300 in the event of subsequent polling from the smartphone 300 with a character string of the last four digits as an argument. Further, while returning “Received” to the smartphone 300, the server apparatus 100 sends the full MAC address of the HEMS controller. It should be noted that the polling is performed, for example, at intervals of 5 seconds. In step S616, the server apparatus 100 unlocks the mutex (=V1) after having returned “Received” to the smartphone 300. Furthermore, the server apparatus 100 erases, from the hash table A, the point in time where the mutex (=V1) was locked.

FIG. 15 is a flow chart for explaining the flow of a process (routine) that is regularly executed by the server apparatus 100. The server apparatus 100 executes the process every 100 ms, for example. As shown in FIG. 15, in step S702, the server apparatus 100 reads out, from the hash table A, all pieces of data “(key, value)” contained in the hash table A, and enumerates them. After that, the server apparatus 100 repeats steps S704, S706, S708, and S710.

In step S704, the server apparatus 100 determines whether the plural pieces of data thus enumerated include the next data “(key, value)=(K1, V1)”.

If having determined that the plural pieces of data thus enumerated include such data (YES in step S704), the server apparatus 100 determines, in step S706, whether 1 minute or longer has elapsed since the point in time where the mutex (=V1) was locked. If having determined that the plural pieces of data thus enumerated do not include such data (NO in step S704), the server apparatus 100 ends the process (single routine).

If having determined that 1 minute or longer has not elapsed (NO in step S706), the server apparatus 100 returns to step S704. If having determined that 1 minute or longer has elapsed (NO in step S706), the server apparatus 100 appends the time-out to the values of the hash table A in step S708. In step S710, the server apparatus 100 returns “Timeout” to the smartphone 300 in the event of subsequent polling from the smartphone 300 with a character string of the last four digits as an argument. It should be noted that the server apparatus 100 returns “Waiting” to the smartphone 300 unless the server apparatus 100 has received a trial communication from the HEMS controller 700 and unless one minute has elapsed.

In step S712, the server apparatus 100 unlocks the mutex (=V1) after having returned “Timeout” to the smartphone 300. Furthermore, the server apparatus 100 erases, from the hash table A, the point in time where the mutex (=V1) was locked.

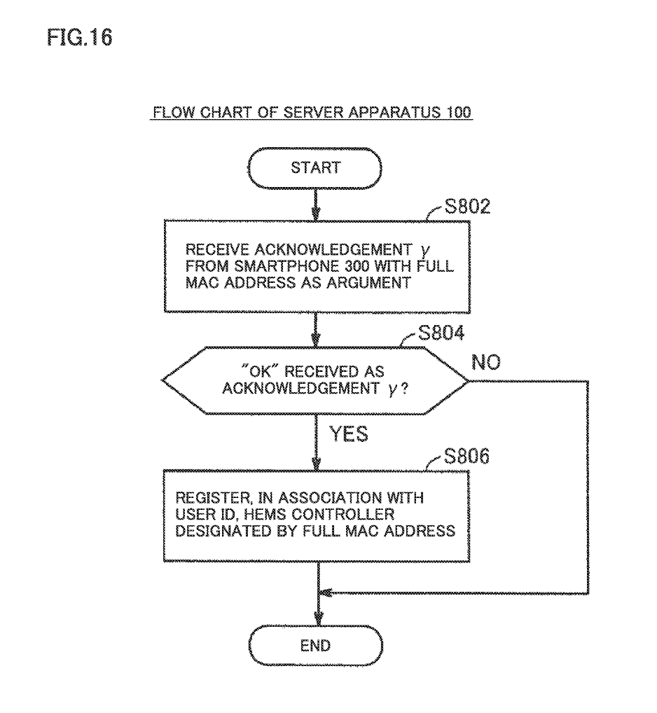

FIG. 16 is a flow chart for explaining the flow of a process that the server 100 executes upon receiving an acknowledgement γ from the smartphone 300. In step S804, the server apparatus 100 receives the acknowledgement γ from the smartphone 300 with the full MAC address as an argument. If having determined that it has not received “OK” (NO in step S804), the server apparatus 100 ends the series of actions. If having determined that it has received “OK” (YES in step S804), the server apparatus 100 proceeds to step S806, in which the server apparatus 100 registers, in association with the user ID, the HEMS controller designated by the full MAC address.

(b5. Database)

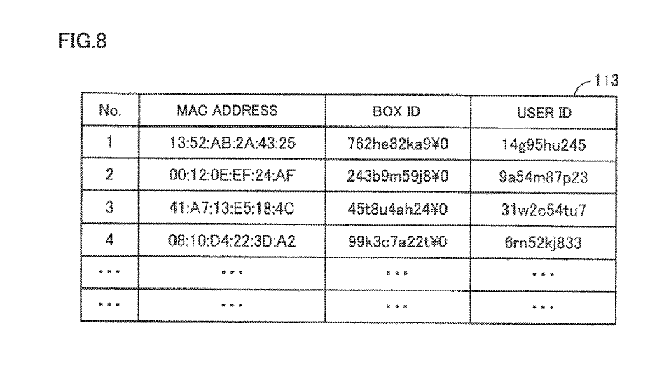

FIG. 8 is a diagram for schematically explaining a configuration of a database 113 stored in the server apparatus 100. The database 113 is a database for registering the HEMS controller 700 in the server apparatus 100. The server apparatus 100 uses the database 113 to manage HEMS controllers.

As shown in FIG. 8, the database 113 stores MAC addresses, box IDs, and user IDs in association with one another. It should be noted that the server apparatus 100 acquires, through a trial communication, the MAC address of the HEMS controller that is currently being dealt with (sequence SQ6 of FIG. 3).

As for the HEMS controller 700, the server apparatus 100 stores the MAC address “00120EEF24AF”, the box ID, and the user ID “9a54m87p23”, which was used to log in to the server apparatus 100, in association with one another.

(b6. User Interface of Smartphone 300)

FIGS. 9 and 10 are diagrams for explaining a user interface of the smartphone 300.

FIG. 9(A) is a diagram showing a screen 3191 that is displayed on a touch screen 319 in a case where the user has selected “Registration of HEMS Controller” from the menu. The screen 3191 includes a button 390 that receives an input for returning to the menu and a button 391 that receives an input for proceeding to the next step.

When the user selects the button 391, the smartphone 300 changes from displaying the screen 3191 of FIG. 9(A) on the touch screen 319 to displaying a screen 3192 of FIG. 9(B) on the touch screen 319. Note, however, that FIG. 9(B) shows the screen 3192 with a four-digit character string “24AF” already inputted to an input box 392 by the user. That is, immediately after the transition from the screen 3191 of FIG. 9(A) to the screen 3192 shown in FIG. 9(B), there is no four-digit character string inputted to the input box 381.

When the input box 392 is put into an active state, the smartphone 300 further displays a software keyboard. With the software keyboard, the user can input a four-digit character string to the input box 392. When the user selects a send button 393 on the screen 3192, the smartphone 300 sends, to the server apparatus 100, the four-digit character string thus inputted. After having sent, to the server apparatus 100, the four-digit character string thus inputted, the smartphone 300 makes a screen transition from the screen 3192 of FIG. 9(B) to a screen 3193 of FIG. 9(C) or a screen 3194 of FIG. 9(D). Specifically, upon receiving “Accepted” as an acknowledgement α, the smartphone 300 makes a transition to the screen 3193 of FIG. 9(C). Alternatively, upon receiving “Rejected” as an acknowledgement α, the smartphone 300 makes a transition to the screen 3194 of FIG. 9(D).

Upon receiving “Accepted” as an acknowledgement α, the smartphone 300 starts polling to the server apparatus 100 as mentioned above. As a response to the polling, the server apparatus 100 returns a Waiting response, a Received response, or a Timeout response. The smartphone 300 displays the screen 3193 of FIG. 9(C) (continues the polling) unless the smartphone 300 has received an acknowledgment request for the MAC address of the HEMS controller from the server apparatus 100 and unless one minute has elapsed (Waiting response).

Upon receiving an acknowledgment request for the MAC address of the HEMS controller from the server apparatus 100 (Received response), the smartphone 300 changes from displaying the screen 3193 of FIG. 9(C) on the touch screen 319 to displaying a screen 3195 of FIG. 10(A) on the touch screen 319. In a case where the smartphone 300 cannot receive an acknowledgment request for the MAC address of the HEMS controller from the server apparatus 100 even when one minute has elapsed since the reception of “Accepted” as the acknowledgement α (Timeout response), the smartphone 300 makes a transition from the screen 3193 of FIG. 9(C) to a screen 3196 shown in FIG. 10(B).

When, in a state where the screen 3194 of FIG. 9(D) is being displayed on the touch screen 319, the user selects a button 394 for redoing registration processing, the smartphone 300 makes a screen transition from the screen 3194 of FIG. 9(D) to the screen 3191 of FIG. 9(A).

FIG. 10(A) is a diagram showing a screen that is displayed upon reception of an acknowledgment request for the MAC address of the HEMS controller 700 from the server apparatus 100 (sequence SQ16 of FIG. 3).

As shown in FIG. 10(A), the smartphone 300 displays a comment, the acknowledge button 395, and the cancel button 396 on the touch screen 319. By so doing, the smartphone 300 allows the user to acknowledge whether the MAC address contained in the comment displayed on the screen 3195 matches the MAC address on the back surface of the HEMS controller 700.

In a case where the acknowledgement button 395 has been selected by the user on the basis of a match between the MAC addresses, the smartphone 300 notifies the server apparatus 100 of “OK” as an acknowledgement γ and makes a screen transition from the screen 3195 of FIG. 10(A) to a screen 3197 of FIG. 10(C). In this case, the server apparatus 100 registers the HEMS controller 700 in association with the user ID. Specifically, the server apparatus 100 registers the MAC address of the HEMS controller 700, the box ID, and the user ID in association with one another as indicated by No. 2 in the database 113.

In a case where the cancel button 396 has been selected by the user on the basis of a mismatch between the MAC addresses, the smartphone 300 notifies the server apparatus 100 of “NG” as an acknowledgement γ and makes a screen transition from the screen 3195 of FIG. 10(A) to a screen 3198 of FIG. 10(D). In this case, the server apparatus 100 does not register the HEMS controller 700 in association with the user ID.

It should be noted that when, in a state where the screen 3196 of FIG. 10(B) is being displayed on the touch screen 319, the user selects a button 397 for redoing registration processing, the smartphone 300 makes a screen transition from the screen 3196 of FIG. 10(B) to the screen 3191 of FIG. 9(A). Further, when, in a state where the screen 3198 of FIG. 10(D) is being displayed on the touch screen 319, the user selects a button 399 for redoing registration processing, the smartphone 300 makes a screen transition from the screen 3196 of FIG. 10(D) to the screen 3191 of FIG. 9(A). Furthermore, when, in a state where the screen 3197 of FIG. 10(C) is being displayed on the touch screen 319, the user selects a button 398 for returning to the menu, the smartphone 300 makes a screen transition from the screen 3197 of FIG. 10(C) to a menu screen (not illustrated).

By carrying out the registration procedure in accordance with the screens of FIGS. 9 and 10, the user can surely succeed in registering the smartphone 300 and the HEMS controller 700 on the server apparatus 100.

As mentioned above, first, the server apparatus 100 side is provided with the step of executing exclusive control with the last four digits of an MAC address. If the last-four digits of the MAC address has already been received from another user, the server apparatus 100 side returns “Rejected” and prompts the user to redo registration after some time. The server apparatus 100 side can simultaneously receive the last four digits of MAC addresses from a plurality of users, as long as the last four digits of one MAC address are different from those of another.

Further, finally, as shown in FIG. 10(A), the step of prompting the user to check the full MAC address of the HEMS controller 700 is provided. This is because, during a period of a trial communication, a third person may suddenly makes a mistake in operating the HEMS controller 700A to start a trial communication. In this case, the full MAC address displayed in FIG. 10(A) may be different from that of the HEMS controller 700 of the user. If, as a result of checking the full MAC address being displayed, the user has found that the MAC address is wrong, the user can cancel the registration. In that case, the user is prompted to redo registration.

It should be noted that such a process is effective because the present system is a system in which the smartphone 300 and the HEMS controller 700 communicate with the server apparatus 100 through different communication lines from each other. This is also because, in such a system, a smartphone 300 or HEMS controller 700 of another user is highly likely to perform a trial communication at the same timing. In the case of a mechanism in which the smartphone 300 and the HEMS controller 700 are under one roof and present on the same network as in the case of Wi-Fi connections, it is not necessary to take any other user into consideration and it is easy to directly search for the HEMS controller 700 through the smartphone and register the HEMS controller 700.

### C. Functional Configuration

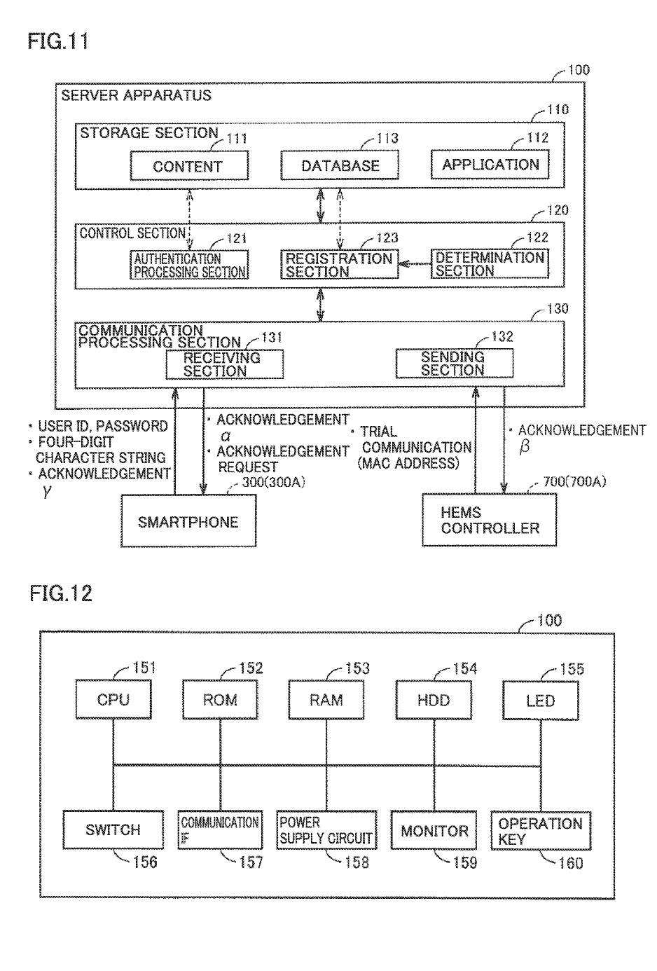

FIG. 11 is a functional block diagram for explaining a functional configuration of the server apparatus 100. As shown in FIG. 11, the server apparatus 100 includes a storage section 110, a control section 120, and a communication processing section 130. The storage section 110 stores the content 111, an application 112, and the database 113 (FIG. 8). The control section 120 includes an authentication processing section 121, a determination section 122, and a registration section 123. The communication processing section 130 includes a receiving section 131 and a sending section 132.

The content 111 is displayed by the browsers of the smartphones 300 and 300A. Specifically, the content 111 is content that is displayed on the smartphones 300 and 300A in a state where the smartphones 300 and 300A have logged in to the server apparatus 100. The application 112 is an application for the server apparatus 100 to communicate with the HEMS controllers 700 and 700A.

The communication processing section 130 is a communication interface for communicating with the smartphones 300 and 300A and the HEMS controllers 700 and 700A. The receiving section 131 receives user IDs, passwords, four-digit character strings, and acknowledgements γ from the smartphones 300 and 300A. Further, the receiving section 131 receives trial communications from the HEMS controllers 700 and 700A. The sending section 132 sends acknowledgements α and acknowledgement requests for the MAC addresses of the HEMS controllers to the smartphones 300 and 300A. Further, the sending section 132 sends acknowledgements β to the HEMS controllers 700 and 700A.

A process that is executed by the communication system 1 is described below with reference to FIG. 11.

(1) The communication system 1 includes the server apparatus 100 and the smartphones 300 and 300A, which become capable of accessing the server apparatus 100 through authentication based on the user IDs.

The authentication processing section 121 of the server apparatus 100 performs authentication (personal authentication) based on a user ID and a password. Upon receiving an input of a four-digit character string (first identification information) after the authentication, the smartphone 300 sends the four-digit character string to the server apparatus 100 via a 3G or LTE line (first communication line).

The receiving section 131 of the server apparatus 100 receives, from the HEMS controller 700, a MAC address (second identification information) unique to the HEMS controller 700 that has been sent via a communication line (second communication line) with the broadband router.

Upon reception of the four-digit character string and the MAC address, the determination section 122 of the server apparatus 122 determines whether the four-digit character string received from the smartphone 300 matches the last four digits of the MAC address received from the HEMS controller 700. More specifically, the determination section 122 determines whether the first identification information matches a character string of a predetermined number of digits of the media access control address.

If the four-digit character string received from the smartphone 300 matches the last four digits of the MAC address received from the HEMS controller 700, the registration section 123 of the server apparatus 100 registers the HEMS controller 700 in association with the user ID. Specifically, the server apparatus 100 updates the database 113.

The foregoing configuration enables the HEMS controller 700 to be registered in the server apparatus 700 by a particular user (i.e. the user of the smartphone 300 who possesses the user ID on which the authentication is based).

Incidentally, each digit of the four-digit character string is in hexadecimal form. Therefore, in theory, the execution of exclusive control based on four-digit character strings enables the server apparatus 100 to accept 65536, i.e. the forth power of 16, HEMS controllers during the same time period.

(2) Further, the server apparatus 100 registers the HEMS controller 700 by associating the MAC address with the user ID. Without being limited to this, the server apparatus 100 may register the HEMS controller 700, for example, by associating, with the user ID, identification information unique to the HEMS controller 700 that has been generated from the MAC address on the basis of a predetermined rule. Alternatively, the server apparatus 100 may register the HEMS controller 700 by associating, with the user ID, identification information irrelevant to the MAC address that satisfies all of the aforementioned three conditions (i) to (iii). It should be noted that an example of the predetermined rule is a rule by which the colons (:) of the MAC address are substituted by hyphens (-).

(3) Furthermore, the server apparatus 100 is capable of communicating with the HEMS controller 700A, as well as the HEMS controller 700, via a communication line (second communication line) with the broadband router. In a case where the receiving section 131 of the server apparatus 100 has received, from the smartphone 300, a command to control a home appliance, the control section 120 uses the sending section 132 to send the command to that one of the HEMS controllers 700 and 700A which is specified by the MAC address associated with the user ID. This registration allows the user of the smartphone 300 to send the command to the HEMS 700.

(4) Further, if the receiving section 131 of the server apparatus 100 has received the MAC address from the HEMS controller 700 during a first period between the reception of the four-digit character string from the smartphone 300 and the passage of a predetermined period of time (which, in the present embodiment, is 1 minute), the determination section 122 determines whether the four-digit character string matches the last four digits of the MAC address. The foregoing configuration requires the user to perform an operation of sending the MAC address from the HEMS controller 700 so that the server apparatus 100 can receive the MAC address during the first period. This makes it possible to set a time limit for one user to perform a single registration operation. This allows a larger number of users to perform registration processing per unit time (e.g. 1 hour or 24 hours), as compared with a case where no time limit is set.

(5) Furthermore, in a case where the receiving section 131 of the server apparatus 100 has received, from the smartphone 300A, a character string that is identical to the four-digit character string sent from the smartphone 300, the determination section 122 does not make, during a second period between the reception of the identical character string and the passage of a predetermined period of time (1 minute), a determination based on the four-digit character string sent from the smartphone 300 (i.e. a determination as to whether the four-digit character string matches the last four digits of the MAC address). That is, the server apparatus 100 performs exclusive control. Such a configuration allows the server apparatus 100 to prevent parallel execution of registration processing of a plurality of HEMS controllers whose MAC addresses have the identical last four digits.

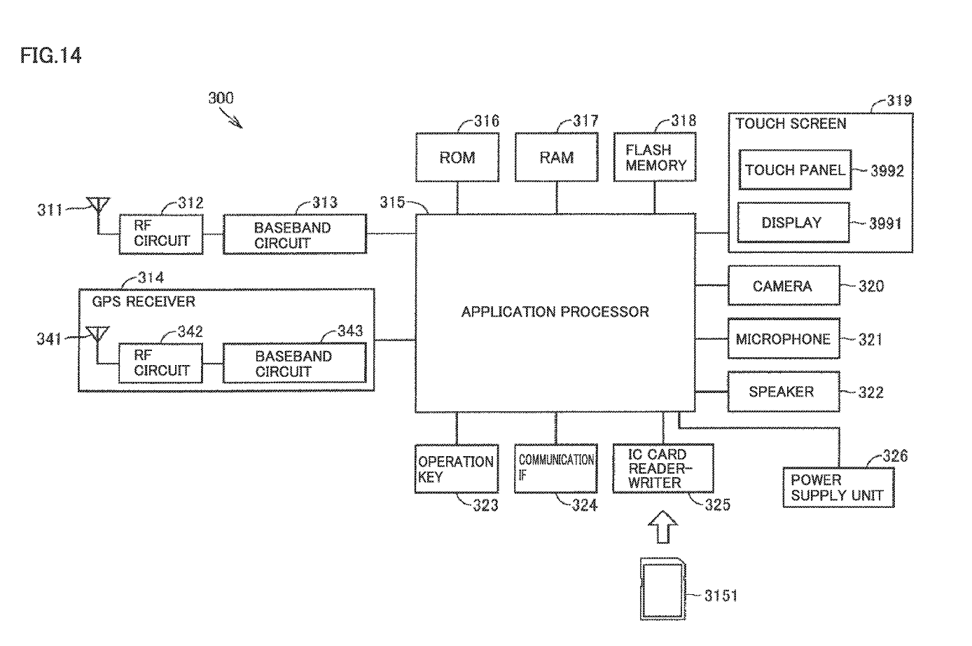

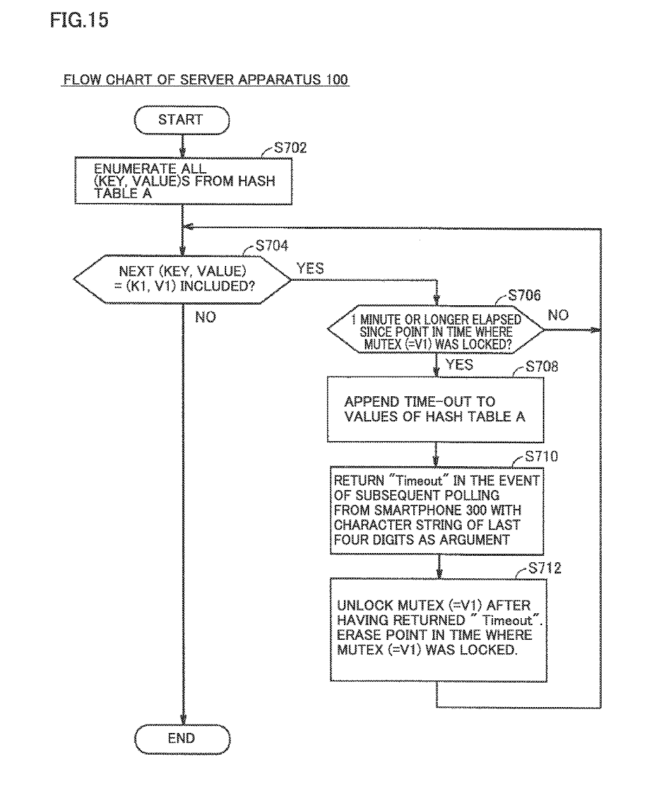

(6) Further, if having determined that the four-digit character string matches the last four digits of the MAC address, the server apparatus 100 sends the MAC address to the smartphone 300 through the sending section 132. The smartphone 300 outputs, to a display (i.e. a display 3991 of FIG. 14) of the smartphone 300, the MAC address sent from the server apparatus 100. Upon selection of the acknowledge button 395 (upon receiving a predetermined input) with the MAC address displayed on the display, the smartphone 300 notifies the server apparatus 100 of “OK” (predetermined signal) as an acknowledgement γ. If “OK” has been received as the acknowledgement γ, the registration section 123 of the server apparatus 100 stores the MAC address and the user ID in association with each other. The foregoing configuration makes it possible to reduce the possibility of an unintended HEMS controller being registered in association with the user ID.

### D. Hardware Configuration

(d1. Server Apparatus 100)

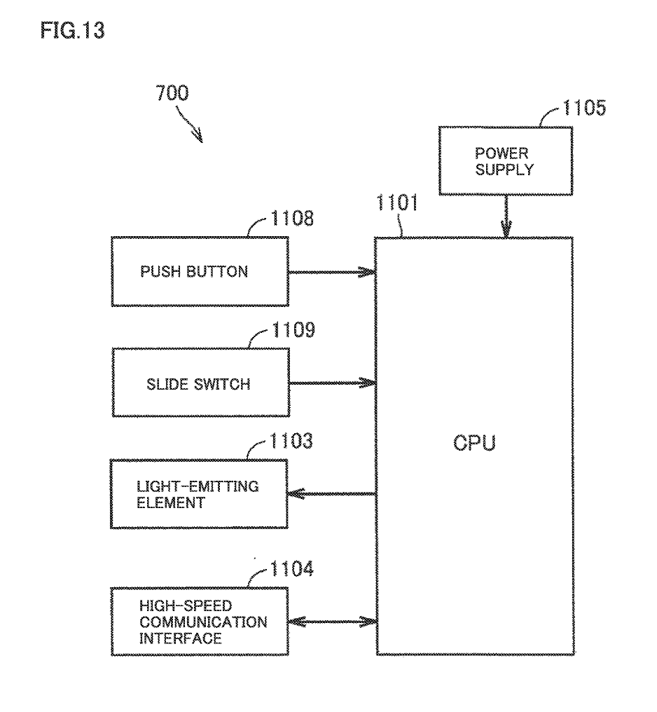

FIG. 12 is a diagram showing a typical example of a hardware configuration of the server apparatus 100. As shown in FIG. 12, the server apparatus 100 includes, as main constituent elements, a CPU 151 that executes a program, a ROM 152 in which data is stored in a nonvolatile manner, a RAM 153 in which data generated by the execution of the program by the CPU 151 or data inputted via an input device (not illustrated) is stored in a volatile manner, an HDD 154 in which data is stored in a nonvolatile manner, an LED 155, a switch 156, a communication IF (interface) 157, a power supply circuit 158, a monitor 159, and an operation key 160. These constituent elements are connected to one another through a data bus.

The power supply circuit 158 is a circuit that lowers the voltage of a commercial power supply received via an outlet and supplies power to each component of the server apparatus 100. The switch 156 is a button switch such as a main power supply switch for switching between feeding and not feeding power to the power supply circuit 158 or any of the other various push-button switches. The monitor 159 is a device for displaying various types of data.

The communication IF 157 performs a process of sending data to the HEMS controller 700, a process of receiving data sent from the HEMS controller 700, a process of sending data to the smartphone 300, and a process of receiving data sent from the smartphone 300.

The LED 155 is any of various indicator lamps that indicates the operating state of the server apparatus 100. For example, the LED 155 indicates the on- or off-state of the main power supply of the server apparatus 100, the readout or writing state to the HDD 154, and the like. The operation key 160 is a key (keyboard) that a user of the server apparatus 100 uses to input data to the server apparatus 100.

The processes in the server apparatus 100 are achieved by each piece of hardware and software that is executed by the CPU 151. Such software may be stored in advance in the HDD 154. Further, the software may be stored in another storage medium for distribution as a program product. Alternatively, the software may be provided as a downloadable program product by an information provider connected to the so-called Internet. Such software is temporarily stored in the HDD 154 after being read from the storage medium by a reading device or downloaded via the communication IF 157 or the like. The software is read out from the HDD 154 by the CPU 151 and stored in the form of an executable program in the RAM 153. The CPU 151 executes the program.

Those constituent elements illustrated in FIG. 12 which constitute the server apparatus 100 are common. Therefore, it can be said that an essential part of the present invention is the software stored in the RMA 153, the HDD 154, and the storage medium or the software that can be downloaded via the network. It should be noted that the operation of each piece of hardware of the server apparatus 100 is well-known and, as such, is not repeatedly described in detail.

It should be noted that, without being limited to a DVD-RAM, the storage medium may be a medium that retains the program in a fixed manner, such as a DVD-ROM, a CD-ROM, an FD, a hard disk, a magnetic tape, a cassette tape, an optical disk, or a semiconductor memory such as an EEPROM or a flash ROM. Further, the storage medium is a non-transitory medium from which a computer can read the program or the like. Further, the program as used herein encompasses not only a program that can be directly executed by a CPU, but also a program in a source program format, a compressed program, an encrypted program, and the like.

(d2. HEMS Controller 700)

FIG. 13 is a block diagram of the HEMS controller 700. As shown in FIG. 13, the HEMS controller 700 includes a CPU 1101, the light-emitting element 1103, a high-speed communication interface 1104, a power supply 1105, the push button 1108, a slide switch 1109, and a reset switch (not illustrated).

The high-speed communication interface 1104 is an interface for performing communication with the broadband router 600 over Ethernet (registered trademark). The power supply 1105 supplies electric power to the CPU 1101.

The CPU 1101 is connected to the light-emitting element 1103, the high-speed communication interface 1104, the power supply 1105, the push button 1108, and the slide switch 1109. The CPU 1101 controls an overall operation of the HEMS controller 700. The CPU 1101 receives inputs from the push button 1108 and the slide switch 1109. Further, the CPU 1101 gives an output instruction to the light-emitting element 1103.

(d3. Smartphone 300)

FIG. 14 is a diagram showing a hardware configuration of the smartphone 300. As shown in FIG. 14, the smartphone 300 includes an antenna 311, an RF (radio frequency) circuit 312, a baseband circuit 313, a GPS receiver 314, an application processor that executes a program, a ROM (read-only memory) 316, a RAM (random access memory) 317, a NAND-type flash memory 318, the touch screen 319, a camera 320, a microphone 321, a speaker 322, an operation key 323 that receives the inputting of an instruction by the user, a communication IF (interface) 324, an IC (integrated circuit) card reader-writer 325, and a power supply unit 326. The touch screen 319 is constituted by including the display 3991 and a touch panel 3992.

The GPS receiver 314 includes an antenna 541, an RD circuit 542, and a baseband circuit 543. The GPS receiver 314 receives a signal from a GPS satellite via the antenna 541. Furthermore, the GPS receiver 314 output results of processing in the RD circuit 312 and the baseband circuit 543 (i.e. current location information) to the application processor 315. It should be noted that the current location information is information that indicates a latitude, a longitude, and an altitude.

The antenna 311, the RD circuit 312, and the baseband circuit 313 are used for wireless communication with another mobile terminal, a fixed-line phone, and a PC (personal computer) via a base station. Specifically, the antenna 311, the RD circuit 312, and the baseband circuit 313 are used for the smartphone 300 to perform communication over a mobile telephone network.

The flash memory 318 is a nonvolatile semiconductor memory. In the flash memory 318, various types of data such as various programs for controlling the smartphone 300, data generated by the smartphone 300, and data acquired from an external device located on the outside of the smartphone 300 are stored in a volatile manner.

The constituent elements 313 to 326 are connected to one another through a data bus. The IC card reader-writer 325 is loaded with a memory card 3151.

The processes in the smartphone 300 are achieved by each piece of hardware and software that is executed by the CPU 315. Such software may be stored in advance in the flash memory 318. Further, the software may be stored in the memory cart 3151 or another storage medium for distribution as a program product. Alternatively, the software may be provided as a downloadable program product by an information provider connected to the so-called Internet. Such software is temporarily stored in the flash memory 318 after being read from the storage medium by the IC card read-writer 325 or another reading device or downloaded via the antenna 311, the RF circuit 312, and the baseband circuit 313 or via the communication IF 324. The software is read out from the flash memory 318 by the application processor 315 and further stored in the form of an executable program in the flash memory 318. The application processor 315 executes the program.

Those constituent elements illustrated in FIG. 14 which constitute the smartphone 300 are common. Therefore, it can be said that an essential part of the present invention is the software stored in the flash memory 318, the memory card 3151, or another storage medium or the software that can be downloaded via the network. It should be noted that the operation of each piece of hardware of the smartphone 300 is well-known and, as such, is not repeatedly described in detail.

It should be noted that, without being limited to a DVD-ROM, a CD-ROM, and FD, or a hard disk, the storage medium may be a medium that retains the program in a fixed manner, such as a magnetic tape, a cassette tape, an optical disk, an optical card, or a semiconductor memory such as a mask ROM, an EPROM, an EEPROM, or a flash ROM. Further, the storage medium is a non-transitory medium from which a computer can read the program or the like. Further, the program as used herein encompasses not only a program that can be directly executed by a CPU, but also a program in a source program format, a compressed program, an encrypted program, and the like.

### E. Modifications

(1) The foregoing description has taken, as an example, a configuration for determining whether the four-digit character string received from the smartphone 300 matches the last four digits of the MAC address received from the HEMS controller 700. However, this does not imply any limitation.

That is, the server apparatus 100 needs only be configured to, upon receiving the first identification information received from the smartphone 300 and the second identification information received from the HEMS controller 700, determine whether the first identification information matches part of the second identification information, and to register the HEMS controller 700 in association with the user ID if the first identification information matches the part of the second identification information.

(2) The server apparatus 100 may also be configured to, in a case where the second identification information is an MAC address as described above, determine whether the first identification information matches a character string of a predetermined number of digits of the MAC address. The predetermined number of digits may be a number of digits other than the last four digits. For example, the predetermined number of digits may be the last two digits, the last three digits, the first two digits, the first three digits, the first four digits, or the like. Making the predetermined number of digits smaller can reduce the burden of an input operation on the user. On the other hand, making the predetermined number of digits larger makes it possible to register a larger number of HEMS controllers in the server apparatus 100 during the same time period. It is preferable that the predetermined number of digits be determined in consideration of the number of users.

(3) In the foregoing, the server apparatus 100 registers a HEMS controller by associating an MAC address with a user ID. However, as mentioned above, this does not imply any limitation.

(4) Further, the foregoing has described the process of registering a HEMS controller in the server apparatus 100. However, the target to be registered is not limited to a HEMS controller. The present invention is also applicable to a configuration in which an electronic apparatus having a communication function is registered in the server apparatus 100.

(5) The foregoing description has given an example in which the MAC address is written on the back surface of the HEMS controller 700. However, the MAC address may be written in any visible location on a housing of the HEMS controller 700.

### F. Supplementary Note

(1) The second identification information is a media access control address.

(2) The server apparatus determines whether the first identification information matches a predetermined number of digits of the media access control address.

(3) The predetermined number of digits is the last two digits, the last three digits, or the last four digits.

(4) Upon receiving, from another terminal apparatus, identification information that is identical to the first identification information, the server apparatus does not make, during a second period between the reception of the identical identification information and the passage of a predetermined period of time, a determination based on the first identification information sent from the terminal apparatus.

(5) The server apparatus generates third identification information upon receiving the media access control address from the electronic apparatus.

(6) The media access control address is printed on a housing of the electronic apparatus.

(7) The electronic apparatus is a controller in a home energy management system.

(8) The server apparatus performs user authentication based on information for identifying a user sent from the terminal apparatus. The server apparatus includes: a receiving unit that, after the authentication, receives first identification information sent from the terminal apparatus via a first communication line and that receives second identification information sent from the electronic apparatus via a second communication line, the second identification information being unique to the electronic apparatus; a determination unit that, upon receiving the first identification information and the second identification information, determines whether the first identification information matches part of the second identification information; and a registration unit that, if the first identification information matches the part of the second identification information, registers the electronic apparatus in association with the information for identifying the user.

(9) An information processing method is executed in a server apparatus that performs user authentication based on information for identifying a user sent from a terminal apparatus. The information processing method includes the steps of: after the authentication, receiving first identification information sent from the terminal apparatus via a first communication line; receiving second identification information sent from the electronic apparatus via a second communication line, the second identification information being unique to the electronic apparatus; upon receiving the first identification information and the second identification information, determining whether the first identification information matches part of the second identification information; and, if the first identification information matches the part of the second identification information, registering the electronic apparatus in association with the information for identifying the user.

(10) A program controls a server apparatus that performs user authentication based on information for identifying a user sent from a terminal apparatus. The program causes a processor of the server apparatus to execute the steps of: after the authentication, receiving first identification information sent from the terminal apparatus via a first communication line; receiving second identification information sent from the electronic apparatus via a second communication line, the second identification information being unique to the electronic apparatus; upon receiving the first identification information and the second identification information, determining whether the first identification information matches part of the second identification information; and, if the first identification information matches the part of the second identification information, registering the electronic apparatus in association with the information for identifying the user.

It should be understood that the embodiment disclosed herein is illustrative and is not restricted to the above content. The scope of the present invention is defined by the terms of the claims, and is intended to include any modifications within the scope and meaning equivalent to the terms of the claims.

### REFERENCE SIGNS LIST

1, 1A Communication system
10, 20 Building
950, 950, 950A, 960, 960A, 970, 970A Node
90 Internet
100 Server apparatus
110 Storage section
111 Content
112 Application
113 Database
120 Control section
121 Authentication processing section
122 Determination section
123 Registration section
130 Communication processing section
131 Receiving section
132 Sending section
151, 1101 CPU
300, 300A Smartphone
315 Application processor
318 Flash memory
319 Touch screen
392 Input box
393 Send button
395 Acknowledge button
396 Cancel button
400, 400A Base station apparatus
500, 500A MME
600, 600A Broadband router
700, 700A Controller
1103 Light-emitting element
1104 High-speed communication interface
1105 Power supply
1108 Push button
1109 Slide switch
1191 MAC address
3991 Display
3992 Touch panel

1. A communication system comprising:
a server apparatus; and
a terminal apparatus that becomes capable of accessing the server apparatus through authentication based on information for identifying a user,
wherein upon receiving an input of first identification information after the authentication, the terminal apparatus sends the first identification information to the server apparatus via a first communication line,
the server apparatus receives second identification information sent from an electronic apparatus via a second communication line, the second identification information being unique to the electronic apparatus,
upon receiving the first identification information and the second identification information, the server apparatus determines whether the first identification information matches part of the second identification information, and
if the first identification information matches the part of the second identification information, the server apparatus registers the electronic apparatus in association with the information for identifying the user.

2. The communication system according to claim 1, wherein the server apparatus registers the electronic apparatus by associating, with the information for identifying the user, the second identification information or third identification information generated from the second identification information on the basis of a predetermined rule, the third identification information being unique to the electronic apparatus.

3. The communication system according to claim 2, wherein the server apparatus is capable of communicating with one or more other electronic apparatuses, as well as the electronic apparatus, via the second communication line, and
upon receiving, from the terminal apparatus, a command to control a home appliance, the server apparatus sends the command to that one of the plurality of electronic apparatuses which is specified by the second or third identification information associated with the information for identifying the user.

4. The communication system according to claim 2, wherein if having determined that the first identification information matches the part of the second identification information, the server apparatus sends the second identification information to the terminal apparatus,
the terminal apparatus outputs the second identification information to a display of the terminal apparatus,
upon receiving a predetermined input with the second identification information displayed on the display, the terminal apparatus sends a predetermined signal to the server apparatus, and
upon receiving the predetermined signal, the server apparatus stores the second or third identification information and the information for identifying the user in association with each other.

5. The communication system according to claim 1, wherein upon receiving the second identification information during a first period between the reception of the first identification information and passage of a predetermined period of time, the server apparatus determines whether the first identification information matches the part of the second identification information.

6. A method for processing information in a communication system including a server apparatus and a terminal apparatus that becomes capable of accessing the server apparatus through authentication based on information for identifying a user, the method comprising:
a step in which, upon receiving an input of first identification information after the authentication, the terminal apparatus sends the first identification information to the server apparatus via a first communication line;
a step in which the server apparatus receives second identification information sent from an electronic apparatus via a second communication line, the second identification information being unique to the electronic apparatus;
a step in which, upon receiving the first identification information and the second identification information, the server apparatus determines whether the first identification information matches part of the second identification information; and
a step in which if the first identification information matches the part of the second identification information, the server apparatus registers the electronic apparatus in association with the information for identifying the user.
